(19) United States
(12) Patent Application Publication
(10) Pub. No.: US 2026/0128652 A1
(43) Pub. Date: May 7, 2026

(54) LOW IMPEDENCE GROUNDING FOR ELECTRIC MOTORS

(71) Applicant: GM Global Technology Operations LLC, Detroit, MI (US)

(72) Inventors: Alireza Fatemi, Canton, MI (US); Zachary Strand, Salem, OR (US); Sen Jiang Zhou, Troy, MI (US); Jack M. Gayney, Grosse Ile, MI (US); John Patrick Spicer, Plymouth, MI (US)

(21) Appl. No.: 18/934,635

(22) Filed: Nov. 1, 2024

(51) Int. Cl. H02K 11/40; B60K 1/00; H02K 7/00; H02K 9/19

(52) U.S. Cl. CPC H02K 11/40; B60K 1/00; H02K 7/003; H02K 9/19

(57) ABSTRACT

An electric motor grounding system includes a hollow cylinder packed with an electrically conductive media. Rotating seals are connected on the hollow cylinder on opposed ends of the hollow cylinder to retain the conductive media within the hollow cylinder. A rotor shaft is positioned within an electric motor, the rotor shaft having a hollow center internally receiving the hollow cylinder. A metal tube is connected to an electric ground. The metal tube is slidably inserted through the hollow center of the hollow cylinder, the rotor shaft being conductively connected to the electric ground through the metal tube and the conductive media.

### INTRODUCTION

The present disclosure relates to grounding of electric motors.

During electric vehicle operation, one or more electric motors may be used for propulsion of the vehicle. The electric motors include a rotor which axially rotates and thereby via friction generates low impedance electrical charges that need to be dissipated. Providing a grounding path to the axially rotating motor rotor is complicated and may be provided using external grounding paths.

Thus, while current systems and methods to discharge electrical charges from operating electric motors achieve their intended purpose, there is a need for a new and improved system and method to ground vehicle electric motor rotors.

### SUMMARY

According to several aspects, an electric motor grounding system includes a hollow cylinder packed with a conductive media. Rotating seals are connected on the hollow cylinder on opposed ends of the hollow cylinder to retain the conductive media within the hollow cylinder. A rotor shaft is positioned within an electric motor, the rotor shaft having a hollow center internally receiving the hollow cylinder. A metal tube is connected to an electric ground. The metal tube is slidably inserted through the hollow center of the hollow cylinder, the rotor shaft being conductively connected to the electric ground through the metal tube and the conductive media.

In another aspect of the present disclosure, the electric motor includes a housing defining the electric ground, the metal tube being fixedly connected to the housing.

In another aspect of the present disclosure, the rotor shaft rotates with respect to a longitudinal axial centerline of the rotor shaft, the rotor shaft extending through the housing and induced to rotate by passing an electric current through a winding.

In another aspect of the present disclosure, the metal tube is stationary during operation of the electric motor with the hollow cylinder being fixed to and corotating with the rotor shaft.

In another aspect of the present disclosure, a biasing member defining one of a spring and a garter spring is positioned behind a sealing lip acting in one of side compression and vertical compression, the biasing member providing one of an axial force and a radial force to maintain contact between the sealing lip and a shaft surface of the rotor shaft.

In another aspect of the present disclosure, flexible spring-loaded tips are used to maintain contact with the hollow cylinder and to compensate for cylinder surface irregularities.

In another aspect of the present disclosure, the hollow cylinder is formed as first and second cylinder pieces and includes hermetic seals between the first and second cylinder pieces mitigating against ingress of contaminants and moisture into the grounding mechanism.

In another aspect of the present disclosure, slots on at least one of a cylinder surface of the hollow cylinder and an inner diameter surface of the hollow cylinder, the slots directing passage of air into the rotor shaft to enhance ventilation and cooling for the electric motor during operation.

In another aspect of the present disclosure, passages created in the hollow cylinder direct passage of an oil to enable cooling of the rotor and the conductive media.

In another aspect of the present disclosure, surface features extending from the metal tube defining fins, the fins enhancing contact with the conductive media, the conductive media defining a conductive grease.

According to several aspects, an electric motor grounding system includes a vehicle having an electric motor positioned in a housing. A rotor shaft of the electric motor axially rotating within the housing has a hollow center. A hollow cylinder has a cylinder cavity in communication with the hollow center of the rotor shaft. Multiple rotary seals are connected to the hollow cylinder. An electric ground is created between the rotor shaft, the hollow cylinder and the housing to dissipate a parasitic voltage generated by rotation of the rotor shaft.

In another aspect of the present disclosure, a cartridge assembly includes: a conductive grease packed within the hollow cylinder; and the multiple rotary seals are connected in the hollow cylinder on opposed ends of the hollow cylinder to retain the conductive grease within the hollow cylinder.

In another aspect of the present disclosure, a metal tube connected to the housing defining the electric ground, the metal tube slidably inserted through the rotary seals and the hollow center of the hollow cylinder and extending into and making contact with the conductive grease, the rotor shaft being conductively connected to the electric ground through the metal tube and the conductive grease internally receiving the hollow cylinder, and wherein during operation of the electric motor the metal tube remains stationary and the hollow cylinder co-rotates with the rotor shaft.

In another aspect of the present disclosure, the hollow cylinder is created in two pieces including an inner piece and an outer piece, with a hermetic seal and multiple air channels present between the inner piece and outer piece.

In another aspect of the present disclosure, the rotor shaft includes slots on a rotor surface to direct air into the rotor shaft, the slots formed on an inner diameter surface of the rotor shaft.

In another aspect of the present disclosure, a first one of the rotary seals is fixed at a first end of the hollow cylinder and a second one of the rotary seals is fixed at a second end of the hollow cylinder opposite to the first one of the rotary seals. A first tube supplying a coolant to the cylinder cavity has a third one of the rotary seals connecting the first tube to the first one of the rotary seals. A second tube directs the coolant out of the cylinder cavity and has a fourth one of the rotary seals connecting the second tube to the second one of the rotary seals. To remove the parasitic voltage from the hollow cylinder, the first one of the rotary seals, the second one of the rotary seals, the third one of the rotary seals and the fourth one of the rotary seals define a conductive sealing material.

In another aspect of the present disclosure, the third one of the rotary seals is biased in a first sealing direction into sealing contact with the first one of the rotary seals, and the fourth one of the rotary seals is biased in a second sealing direction opposite to the first sealing direction into sealing contact with the third one of the rotary seals.

According to several aspects, a method for forming an electric motor grounding mechanism comprises: filling a portion of a longitudinal cavity of a hollow cylinder with a conductive media; sealing the hollow cylinder hermetically using rotating seals positioned at opposed ends of the portion of the longitudinal cavity of the hollow cylinder and sealing tapes to retain the conductive media within the hollow cylinder; inserting the hollow cylinder into a hollow bore of a rotor shaft of an electric motor; inserting a metal tube into the hollow bore of the rotor shaft and through the conductive media; providing surface features on the metal tube including tilted fins to enhance contact of the metal tube with the conductive media; and connecting the metal tube to an electric ground to electrically ground the rotor shaft through the metal tube and the conductive media.

In another aspect of the present disclosure, the method further includes configuring the metal tube as a hollow tube directing passage of lubrication oil through the metal tube into the hollow bore of the rotor shaft.

In another aspect of the present disclosure, the method further includes forming air passage features on one of an outer surface of the metal tube and an inner surface of the rotor shaft.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a top left perspective view of a vehicle having a low impedance motor grounding system according to an exemplary aspect;

FIG. 2 is a cross-sectional side elevational view of an electric motor taken at section 2 of FIG. 1;

FIG. 3 is an enlarged cross-sectional side elevational view of area 3 of FIG. 2;

FIG. 4 is a cross-sectional end elevational view taken at section 4 of FIG. 3;

FIG. 5 is a cross-sectional end elevational view taken at section 5 of FIG. 3;

FIG. 6 is a cross-sectional side elevational view similar to FIG. 3 of another aspect of a low impedance motor grounding system;

FIG. 7 is a side elevational view of area 7 of FIG. 6;

FIG. 8 is a cross-sectional side elevational view similar to FIG. 6 of another aspect of a low impedance motor grounding system; and

FIG. 9 is a cross-sectional side elevational view of another aspect of a low impedance motor grounding system.

### DETAILED DESCRIPTION

The following description is merely exemplary in nature and is not intended to limit the present disclosure, application, or uses.

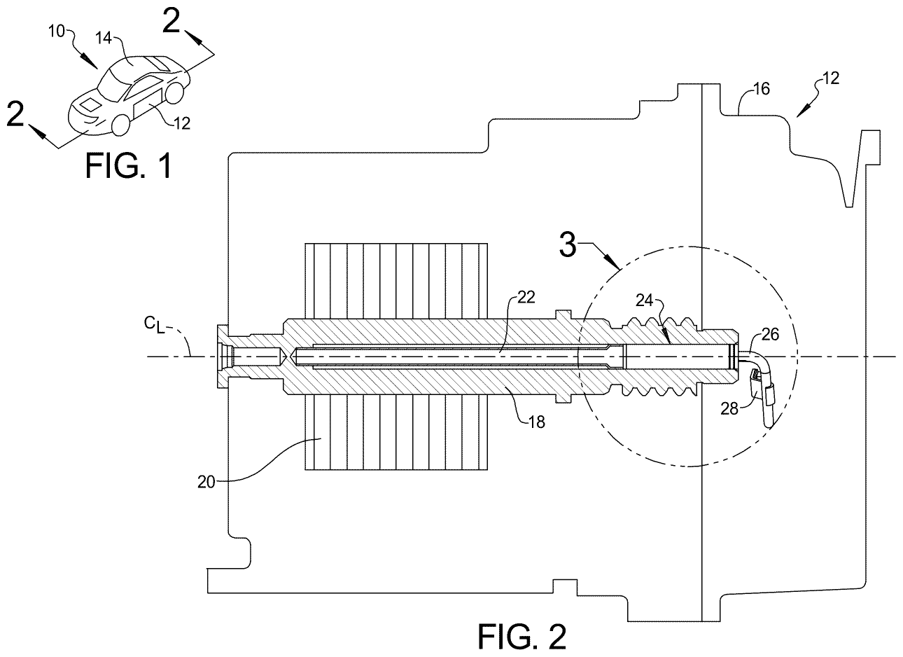

Referring to FIG. 1, a low impedance electric motor grounding system 10 is provided for an electric motor 12 used for propulsion of a vehicle 14. The vehicle 14 may include a battery electric vehicle (BEV) or a battery and engine hybrid powered vehicle, which includes sedans, sport utility vehicles, trucks, vans, autonomously operated vehicles and the like. The electric motor 12 may be positioned at any location of the vehicle 14.

Referring to FIG. 2 and again to FIG. 1, according to several aspects the electric motor 12 includes housing 16. The housing 16 provides multiple components including a shaft 18 which rotates with respect to a longitudinal axial centerline (CL) of the shaft 18. The shaft 18 extends through the housing and is induced to rotate by passing an electric current through a winding 20. A hollow sleeve 22 is disposed within the shaft 18 in axial alignment with the longitudinal axial CL of the shaft 18, which directs flow of a combination coolant and lubricant such as oil through the electric motor 12. A cartridge assembly 24 is also disposed in axial alignment with the longitudinal axial CL of the shaft 18 and is co-axially aligned with the hollow sleeve 22. The cartridge assembly 24 includes a hollow cylinder which receives a rigid tube 26 within a longitudinal cavity of the cartridge assembly 24.

The cartridge assembly 24 performs multiple functions. These functions include delivery of the coolant to the hollow sleeve 22, providing a grounding feature to remove parasitic voltage generated by axial rotation of the shaft 18 and providing access for a non-rotating inner tube 26 to be mounted to the housing 16 and extended into the cartridge assembly 24 providing a grounding path the housing 16 and for delivery of the coolant into the shaft 18. A bracket 28 fixes a portion of the inner tube 26 external to the cartridge assembly 24 to the housing 16 to provide a grounding path for grounding a parasitic voltage of the rotating shaft 18 to the housing 16.

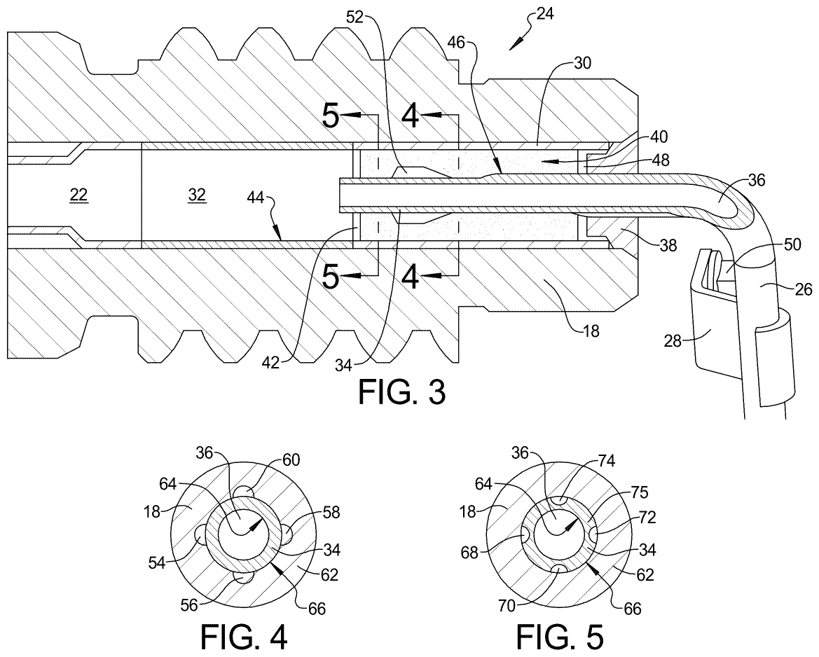

Referring to FIG. 3 and again to FIGS. 1 and 2, the cartridge assembly 24 includes a hollow cylinder 30 which contacts the hollow sleeve 22 extending through the shaft 18. The hollow cylinder 30 directly contacts the shaft 18 and thereby co-rotates with the shaft 18. The hollow cylinder 30 includes a longitudinal cavity 32 which receives an extending portion 34 of the inner tube 26. A hollow passageway 36 of the inner tube 26 communicates with the longitudinal cavity 32 to deliver coolant to the hollow sleeve 22. An open end 38 of the hollow cylinder 30 is exposed to atmosphere. A conductive media 40 is positioned within a portion of the longitudinal cavity 32 and surrounds a substantial length of the extending portion 34. According to several aspects the conductive media 40 may include a conductive grease which enhances the flow of the parasitic voltage between contact points described below. Examples of the conductive media 40 include but are not limited to carbon-graphite or a metal. Examples of the metal used for the conductive media 40 may include copper, lithium, zinc, aluminum and silver.

The conductive media 40 is captured within the hollow cylinder 30 of the cartridge assembly 24 and retained by a first rotating seal 42 which contacts an inner wall 44 of the hollow cylinder 30 and an outer wall 46 of the extending portion 34 and a second rotating seal 48 which also contacts the inner wall 44 of the hollow cylinder 30 and the outer wall 46 of the extending portion 34. A path for parasitic voltage discharge is thereby formed from the hollow sleeve 22 to the cylinder 30 via the inner wall 44 of the cylinder 30, through the conductive media 40 to the outer wall 46 of the extending portion 34 and to the housing 18 acting as a ground via the bracket 28 which is fixed to the housing 18 using a fastener 50. To maintain consistency of the conductive media 40 and to maintain consistent contact between the conductive media 40 with the inner wall 44 of the cylinder 30 and the outer wall 46 of the extending portion 34, one or more surface features 52 are fixed to the outer wall 46 of the extending portion 34 and displace the conductive media 40 as the cylinder 30 axially rotates about the stationary extending portion 34. According to several aspects, the surface features 52 may include a fin, a raised ridge, a ripple, and the like.

Referring to FIG. 4 and again to FIG. 3, according to several aspects to improve cooling of the electric motor 12, multiple cooling channels may be created longitudinally in an inner wall of the shaft 18. The cooling channels may provide for cooling air flow or a fluid such as the coolant and may be configured in approximately 90 degree increments. The cooling channels may include a first cooling channel 54, a second cooling channel 56, a third cooling channel 58 and a fourth cooling channel 60. The cooling channels are formed in a wall 62 of the shaft 18 extending outward from an inner wall 64 of the shaft and are positioned outward of an outer wall 66 of the extending portion 34.

Referring to FIG. 5 and again to FIGS. 3 and 4, according to several aspects the cooling channels discussed in reference to FIG. 4 above may be modified to be positioned longitudinally in an outer wall of the extending portion 34 in lieu of in the shaft 18. The cooling channels may include a fifth cooling channel 68, a sixth cooling channel 70, a seventh cooling channel 72 and an eighth cooling channel 74. The cooling channels are formed in a wall 75 of the extending portion 34 extending inward from the outer wall 66 of the extending portion 34 and are positioned inward of the inner wall 64 of the shaft 18.

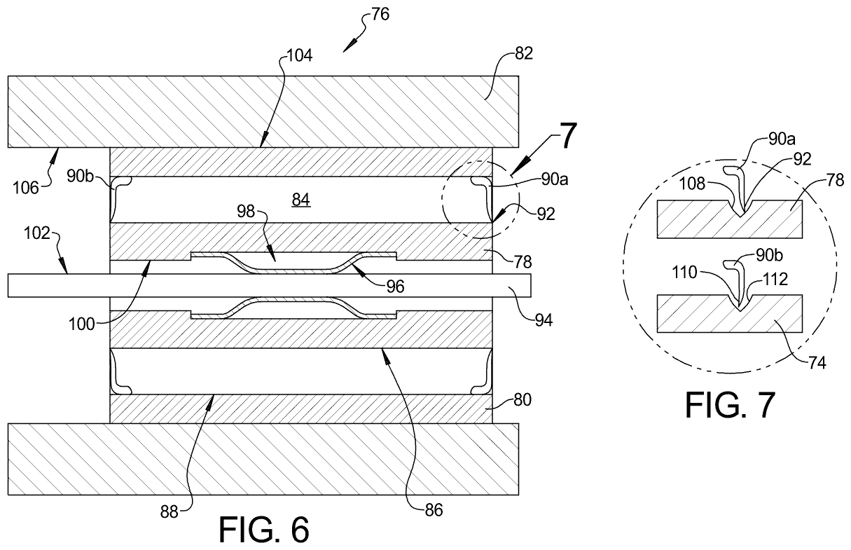

Referring to FIG. 6 and again to FIGS. 1 through 5, according to several aspects additional methods may be used to seal a conductive media for a low impedance motor grounding system 76. A stationary inner tube 78 is disposed within an outer tube 80 which co-rotates with a shaft 82 similar to the shaft 18. A conductive media 84 such as a conductive grease is disposed between an outer wall surface 86 of the inner tube 78 and an inner wall 88 of the outer tube 80. At least a first non-contact seal 90a is positioned between the inner tube 78 and the outer tube 80 at a first end of the conductive media 84 and a second non-contact seal 90b is positioned between the inner tube 78 and the outer tube 80 at an opposite or second end of the conductive media 84. The first non-contact seal 90a and the second non-contact seal 90b include a flexible distal end 92 to prevent loss of the conductive media 84 as the outer tube 80 axially rotates. A coolant tube 94 passing through the inner tube 78 may be position controlled using a tolerance ring 96 acting as a biasing spring. The tolerance ring 96 is disposed and retained within a concave-shaped recess 98 formed on an inner wall 100 of the inner tube 78 and is biased into contact with an outer surface 102 of the coolant tube 94. An outer surface 104 of the outer tube 80 directly and frictionally contacts an inner wall surface 106 of the shaft 82 to induce co-rotation of the shaft 82 and the outer tube 80.

Referring to FIG. 7 and again to FIG. 6, according to several aspects sealing of the non-contact seals including the first non-contact seal 90a and the second non-contact seal 90b discussed above with respect to FIG. 6 may be enhanced by extending the flexible distal end 92 of the first non-contact seal 90a into independent recesses, including a first recess 108 formed in the outer wall surface 86 of the inner tube 78. Similarly, a flexible distal end 110 of the second non-contact seal 90b is extended into a second recess 112 also formed in the outer wall surface 86 of the inner tube 78.

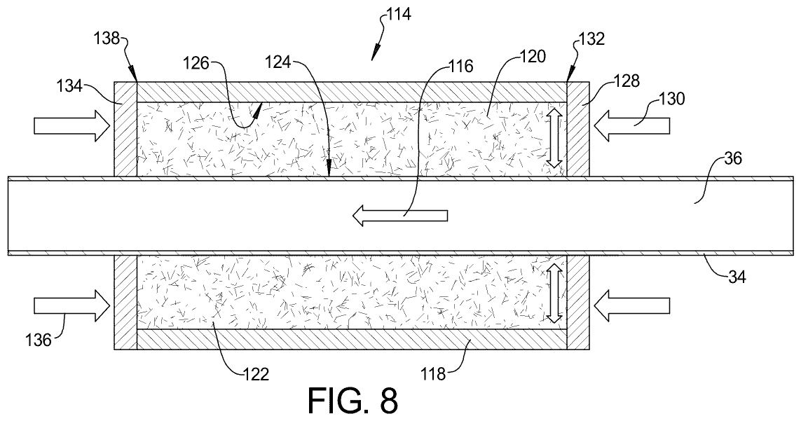

Referring to FIG. 8 and again to FIGS. 2 and 3, according to several aspects additional methods may be used to seal a conductive media for a low impedance motor grounding system 114. The stationary inner tube 34 internally directs flow of a coolant 116 and is disposed within an outer tube 118 which co-rotates with the shaft 18 shown in FIG. 2. A cavity 120 between the inner tube 34 and the outer tube 118 is filled with a conductive media 122. The conductive media 122 such as a conductive grease is disposed between an outer wall surface 124 of the inner tube 34 and an inner wall 126 of the outer tube 118. A first rotary end seal 128 is biased in a first direction 130 into contact with a first end face 132 of the outer tube 118 and thereby rotates with the outer tube 118 while also sealing against the outer wall surface 124 of the inner tube 34. Similarly, second rotary end seal 134 is biased in a second direction 136 opposite to the first direction 130 into contact with a second end face 138 of the outer tube 118 and thereby rotates with the outer tube 118 while also sealing against the outer wall surface 124 of the inner tube 34.

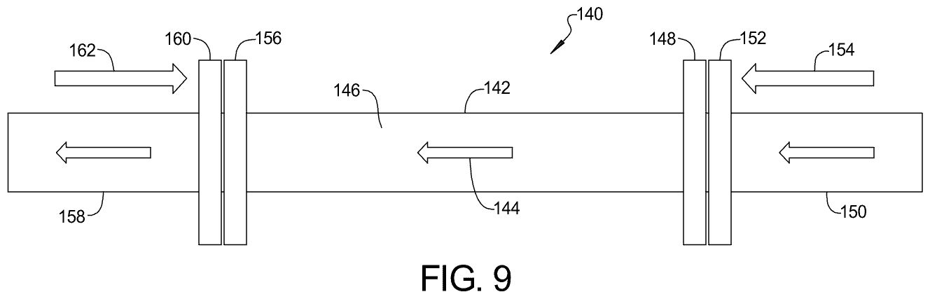

Referring to FIG. 9 and again to FIGS. 1 through 8, according to several aspects additional methods may be used to seal a low impedance motor grounding system 140. A stationary inner tube 142 internally directs flow of a coolant 144 through an inner passageway 146 and is disposed within an outer tube not shown for clarity which co-rotates with the shaft 18 shown in FIG. 2. A first rotary seal 148 is fixed at a first end of the inner tube 142. A second tube 150 supplying the coolant 144 to the inner tube 142 has a second rotary seal 152 fixed at a free end of the second tube 150. The second rotary seal 152 is biased in a first sealing direction 154 into sealing contact with the first rotary seal 148. Similarly, a third rotary seal 156 is fixed at a second end of the inner tube 142. A third tube 158 directs the coolant 144 out of the inner tube 142 and has a fourth rotary seal 160 fixed at a free end of the third tube 158. The fourth rotary seal 160 is biased in a second sealing direction 162 opposite to the first sealing direction 154 into sealing contact with the third rotary seal 156. According to several aspects the conductive media discussed above including the conductive media 40 is omitted from the low impedance motor grounding system 140. To remove parasitic voltage from the inner tube 142, the first rotary seal 148, the second rotary seal 152, the third rotary seal 156 and the fourth rotary seal 160 are provided of a conductive sealing material, for example a carbide material.

The low impedance electric motor grounding system 10 of the present disclosure provides a grounding mechanism which includes a rotating conductive assembly integrated into an electric motor system. The assembly includes a hollow cylinder packed with electrically conductive grease. Rotating seals may be used on both ends of the cylinder for hermetic sealing along with sealing tapes on sides that temporarily seal off openings of the rotating seals. The cylinder is inserted into a hollow rotor shaft of the motor. A metal tube connected to an electric ground is then inserted into the rotor shaft passing through a center of the cylinder. The metal tube may be hollow direct passage of oil for lubrication and motor cooling. During motor operation the metal tube remains stationary while the cylinder is affixed to the rotating rotor shaft. The rotor shaft inside diameter is thereby connected to the electric ground through the metal tube and the conductive grease medium. The metal tube may further include surface features which may include tilted fins to enhance contact with the conductive grease and features including formed flow passages to direct air passage.

The electric motor grounding system 10 including the rotating conductive assembly provides a hollow cylinder packed with an electrically conductive medium such as conductive grease, gel, or a graphite rich plastic, to ground a motor system. Rotating seals are positioned on opposed ends of the cylinder along with sealing tapes on sides of the cylinder to provide a hermetic seal for the assembly. The use of rotating seals ensures that the conductive grease and the electric ground connection remain secure during operation. A metal tube is inserted into the rotor shaft and passes through a center of the hollow cylinder to provides a stationary connection for the electric ground. A rotor shaft inner diameter may thereby be grounded through the conductive grease medium.

A flow of oil through the tube provides additional cooling for the conductive grease which prolongs a life of the conductive grease and reduces maintenance or the need for conductive grease repacking. The inclusion of surface features such as tilted fins on the metal tube enhances contact between the conductive grease and the rest of the assembly to improve an effectiveness of the grounding mechanism. Slots provided on a surface of the cylinder or the inner diameter surface of the shaft direct passage of air into the rotor shaft if needed for additional cooling.

According to several aspects, the cartridge assembly 24 may define a two-piece design, with a first piece hermetically sealed and having air channels provided between inner and outer ones of the two pieces, to achieve a secure seal while allowing for and directing air circulation. To manufacture the conductive assembly and integrate the conductive assembly in an electric motor a rotating seal having a flexible lip is used. The flexible lip is made of an elastomeric material which conforms to surface irregularities, compensates for any roundness variations, and compensates for wear and tear. A spring or garter spring may be positioned behind the sealing lip which functions either in side compression or vertical compression and provides an axial or radial force maintaining contact between the sealing lip and the shaft surface and compensates for wear and tear. A surface treatment is provided on the sealing surface, or the sealing lip may include surface treatments to enhance sealing contact.

The electric motor grounding system 10 of the present disclosure includes a grounding mechanism for an electric motor system, having a rotating conductive assembly consisting of a hollow cylinder filled with electrically conductive media. Rotating seals and sealing tapes hermetically seal the cylinder. The rotating conductive assembly is inserted into the rotor shaft. A metal tube is inserted into the conductive assembly within the rotor shaft passing through a center of the hollow cylinder and is connected to an electric ground. Flexible or spring-loaded tips may be used to maintain contact with the hollow cylinder and to compensate for cylinder surface irregularities. A surface treatment may be applied to the sealed surfaces to reduce surface irregularities. The metal tube is hollow and directs passage of oil as an electric motor coolant. The grounding mechanism may further include surface features on the metal tube, such as tilted fins, to enhance contact between the conductive grease and the metal tube.

The cylinder may include slots on a cylinder surface to direct passage of air into the rotor shaft. The slots may be formed on an inner diameter surface of the rotor shaft. The cylinder may also be constructed in two pieces including an inner piece and an outer piece, with a hermetic seal and air channels present between the inner and outer pieces.

A method for manufacturing a grounding mechanism includes the steps of: filling a hollow cylinder with electrically conductive grease; sealing the cylinder hermetically using rotating seals and sealing tapes to form a rotating conductive assembly; inserting the rotating conductive assembly in a rotor shaft; inserting a metal tube into the rotor shaft and connecting the metal tube to an electric ground. The method may also include: using flexible or spring-loaded tips to maintain contact with the cylinder to compensate for cylinder surface irregularities; and applying a surface treatment to surfaces of the cylinder to reduce cylinder surface irregularities. An electric motor system may incorporate the grounding mechanism above.

The electric motor grounding system 10 of the present disclosure offers several advantages including an electric grounding mechanism providing an effective electric ground for an electric motor system. By connecting the rotor shaft to the electric ground through the conductive assembly and the metal tube, electric charges are dissipated. Use of electrically conductive grease within the hollow cylinder enhances conductivity of the grounding mechanism. Hermetic seals prevent the ingress of contaminants or moisture into the grounding mechanism to maintain the integrity and functionality of the grounding system, reducing the risk of corrosion or electrical failures. The electric grounding mechanism offers flexibility by incorporating features such as slots on a cylinder surface or inner diameter surface for the passage of air into the rotor shaft if needed to enhance ventilation and cooling for the electric motor during operation. The cylinder may be optionally constructed in two pieces having a first piece and a second piece with air channels. The hollow metal tube includes passages direct passage of oil to enable cooling of the rotor as well as the grease while maintaining the electric grounding functionality which increases a grease life span.

What is claimed is:

1. An electric motor grounding mechanism, comprising:
a hollow cylinder packed with a conductive media;
rotating seals connected on the hollow cylinder on opposed ends of the hollow cylinder to retain the conductive media within the hollow cylinder;
a rotor shaft positioned within an electric motor, the rotor shaft having a hollow center internally receiving the hollow cylinder; and
a metal tube connected to an electric ground, the metal tube slidably inserted through the hollow center of the hollow cylinder, the rotor shaft being conductively connected to the electric ground through the metal tube and the conductive media.

2. The electric motor grounding mechanism of claim 1, wherein the electric motor includes a housing defining the electric ground, the metal tube being fixedly connected to the housing.

3. The electric motor grounding mechanism of claim 2, wherein the rotor shaft rotates with respect to a longitudinal axial centerline of the rotor shaft, the rotor shaft extending through the housing and induced to rotate by passing an electric current through a winding.

4. The electric motor grounding mechanism of claim 1, wherein the metal tube is stationary during operation of the electric motor with the hollow cylinder being fixed to and corotating with the rotor shaft.

5. The electric motor grounding mechanism of claim 1, including a biasing member defining one of a spring and a garter spring positioned behind a sealing lip acting in one of side compression and vertical compression, the biasing member providing one of an axial force and a radial force to maintain contact between the sealing lip and a shaft surface of the rotor shaft.

6. The electric motor grounding mechanism of claim 1, including flexible spring-loaded tips used to maintain contact with the hollow cylinder and to compensate for cylinder surface irregularities.

7. The electric motor grounding mechanism of claim 1, wherein the hollow cylinder is formed as first and second cylinder pieces and includes hermetic seals between the first and second cylinder pieces mitigating against ingress of contaminants and moisture into the grounding mechanism.

8. The electric motor grounding mechanism of claim 1, including slots on at least one of a cylinder surface of the hollow cylinder and an inner diameter surface of the hollow cylinder, the slots directing passage of air into the rotor shaft to enhance ventilation and cooling for the electric motor during operation.

9. The electric motor grounding mechanism of claim 1, including passages created in the hollow cylinder directing passage of an oil to enable cooling of the rotor and the conductive media.

10. The electric motor grounding mechanism of claim 1, including surface features extending from the metal tube defining fins, the fins enhancing contact with the conductive media, the conductive media defining a conductive grease.

11. An electric motor grounding system, comprising:
a vehicle having an electric motor positioned in a housing;
a rotor shaft of the electric motor axially rotating within the housing, the rotor shaft having a hollow center;
a hollow cylinder having a cylinder cavity in communication with the hollow center of the rotor shaft;
multiple rotary seals connected to the hollow cylinder; and
an electric ground created between the rotor shaft, the hollow cylinder and the housing to dissipate a parasitic voltage generated by rotation of the rotor shaft.

12. The electric motor grounding system of claim 11, including a cartridge assembly having:
a conductive grease packed within the hollow cylinder; and
the multiple rotary seals are connected in the hollow cylinder on opposed ends of the hollow cylinder to retain the conductive grease within the hollow cylinder.

13. The electric motor grounding system of claim 12, including a metal tube connected to the housing defining the electric ground, the metal tube slidably inserted through the rotary seals and the hollow center of the hollow cylinder and extending into and making contact with the conductive grease, the rotor shaft being conductively connected to the electric ground through the metal tube and the conductive grease internally receiving the hollow cylinder, and wherein during operation of the electric motor the metal tube remains stationary and the hollow cylinder co-rotating with the rotor shaft.

14. The electric motor grounding system of claim 13, wherein the hollow cylinder is created in two pieces including an inner piece and an outer piece, with a hermetic seal and multiple air channels present between the inner piece and outer piece.

15. The electric motor grounding system of claim 13, wherein the rotor shaft includes slots on a rotor surface to direct air into the rotor shaft, the slots formed on an inner diameter surface of the rotor shaft.

16. The electric motor grounding system of claim 11, including:
a first one of the rotary seals fixed at a first end of the hollow cylinder and a second one of the rotary seals fixed at a second end of the hollow cylinder opposite to the first one of the rotary seals;
a first tube supplying a coolant to the cylinder cavity having a third one of the rotary seals connecting the first tube to the first one of the rotary seals; and
a second tube directing the coolant out of the cylinder cavity and having a fourth one of the rotary seals connecting the second tube to the second one of the rotary seals; and
wherein to remove the parasitic voltage from the hollow cylinder, the first one of the rotary seals, the second one of the rotary seals, the third one of the rotary seals and the fourth one of the rotary seals define a conductive sealing material.

17. The electric motor grounding system of claim 16, wherein:
the third one of the rotary seals is biased in a first sealing direction into sealing contact with the first one of the rotary seals; and
the fourth one of the rotary seals is biased in a second sealing direction opposite to the first sealing direction into sealing contact with the third one of the rotary seals.

18. A method for forming an electric motor grounding mechanism, comprising:
filling a portion of a longitudinal cavity of a hollow cylinder with a conductive media;
sealing the hollow cylinder hermetically using rotating seals positioned at opposed ends of the portion of the longitudinal cavity of the hollow cylinder and sealing tapes to retain the conductive media within the hollow cylinder;
inserting the hollow cylinder into a hollow bore of a rotor shaft of an electric motor;
inserting a metal tube into the hollow bore of the rotor shaft and through the conductive media;
providing surface features on the metal tube including tilted fins to enhance contact of the metal tube with the conductive media; and
connecting the metal tube to an electric ground to electrically ground the rotor shaft through the metal tube and the conductive media.

19. The method of claim 18, further including configuring the metal tube as a hollow tube directing passage of lubrication oil through the metal tube into the hollow bore of the rotor shaft.

20. The method of claim 18, further including forming air passage features on one of an outer surface of the metal tube and an inner surface of the rotor shaft.
